(19) United States
(12) Patent Application Publication
(10) Pub. No.: US 2016/0191914 A1
(43) Pub. Date: Jun. 30, 2016

(54) APPARATUS AND METHOD FOR CONTROLLING DISPLAY APPARATUS

(71) Applicant: SAMSUNG ELECTRONICS LTD., Suwon-si (KR)

(72) Inventors: Min-jung KIM, Seoul (KR); Nam-kyun BEON, Seoul (KR); Hye-hyun HEO, Seoul (KR)

(21) Appl. No.: 14/927,728

(22) Filed: Oct. 30, 2015

(30) Foreign Application Priority Data
Dec. 24, 2014 (KR) 10-2014-0188632

(51) Int. Cl. H04N 17/04; H04N 5/225; H04N 17/02

(52) U.S. Cl. CPC H04N 17/04; H04N 17/02; H04N 5/225

(57) ABSTRACT

A display control apparatus includes a data acquirer and a data processor. The data acquirer acquires a first image by capturing an image of a display apparatus that displays an image of a first pattern, and a second image by capturing an image of the display apparatus that displays an image of a second pattern. The data processor detects a display region that is an image area of the display apparatus, from a third image obtained based on the first image and the second image.

### CROSS-REFERENCE TO RELATED APPLICATION

This application is based on and claims priority under 35 U.S.C. §119 to Korean Patent Application No. 10-2014-0188632, filed on Dec. 24, 2014, in the Korean Intellectual Property Office, the disclosure of which is incorporated by reference herein in its entirety.

### BACKGROUND

1. Field

The disclosure relates to an apparatus and method for controlling a display apparatus, and for example, to an apparatus and method for controlling a display apparatus whereby a display region may be detected from a captured image of the display apparatus.

2. Description of Related Art

When using a display apparatus, a user may want to directly set desired image quality in a professional manner. In order for the user to set the desired image quality, calibration may be performed to adjust properties, such as chromaticity and luminance, of the display apparatus.

When a display apparatus includes only one display module, the properties, such as chromaticity and luminance, at a center portion and an edge portion of a screen of the display apparatus may appear to be different. Accordingly, calibration may be performed to adjust such a difference.

When a display apparatus includes a plurality of display modules, display properties, such as color variation or luminance variation, may be different among the display modules. Accordingly, calibration may be performed to minimize and/or reduce such a difference. Thus, calibration may be widely performed on display apparatuses.

### SUMMARY

One or more examples include an apparatus and method for controlling a display apparatus which may detect a display region from a captured image of the display apparatus.

Additional aspects will be set forth in part in the detailed description which follows and, in part, will be apparent from the description.

According to one or more examples, a display control apparatus includes a data acquiring circuitry configured to acquire a first image by capturing an image of a display apparatus that displays an image of a first pattern, and a second image by capturing an image of the display apparatus that displays an image of a second pattern, and a data processor configured to detect a display region that is an image area of the display apparatus, from a third image obtained based on the first image and the second image.

The image of the first pattern may include an area having a same shape as an area of the image of the second pattern, and the image of the first pattern and the image of the second pattern respectively display different colors in the areas having the same shape.

The image of the first pattern may include a first area and a second area and the image of the second pattern comprises a first area and a second area having the same shape as the first area and second area of the image of the first pattern, the first area and the second area of the image of the first pattern respectively have a first color and a second color, and the first area and the second area of the image of the second pattern respectively have the second color and the first color.

The first color and the second color may be complementary colors of each other.

Each of the first area and the second area may include a plurality of sub-areas that are separated from each other.

A size of the first area may be equal to a size of the second area.

The image of the first pattern and the image of the second pattern may have a same quantity of light.

The data acquiring circuitry may be further configured to acquire a plurality of images by capturing images of the display apparatus that displays images of different patterns, and the data processor may be configured to detect the display region further based on the plurality of images in addition to the first image and the second image.

The data processor may be configured to acquire the third image through a subtraction operation or a summing operation of the first image and the second image, to detect from the third image a plurality of points, each point having a pixel value equal to or greater than a threshold value, and to detect the display region based on the plurality of points.

The data processor may be configured to detect vertices of the display region from among the plurality of points based on positions and pixel values of the plurality of points, and to detect the display region based on the detected vertices.

The data processor may be configured to calibrate the display apparatus based on the detected display region.

The display apparatus may include a plurality of display modules, and each of the plurality of display modules may include at least one of the plurality of sub-areas.

According to one or more examples, a method of controlling a display includes acquiring a first image by capturing an image of a display apparatus that displays an image of a first pattern, and a second image by capturing an image of the display apparatus that displays an image of a second pattern, and detecting a display region that is an image area of the display apparatus from a third image obtained based on the first image and the second image.

The image of the first pattern may include a first area and a second area and the image of the second pattern may include a first area and a second area having a same shape as the first area and second area of the image of the first pattern, the first area and the second area of the image of the first pattern may respectively have a first color and a second color, and the first area and the second area of the image of the second pattern may respectively have the second color and the first color.

The first color and the second color may be complementary colors of each other.

The image of the first pattern and the image of the second pattern may have a same quantity of light.

Detecting the display region may include acquiring the third image through a subtraction operation or a summing operation of the first image and the second image, detecting from the third image a plurality of points, each point having a pixel value equal to or greater than a threshold value, and detecting the display region based on the plurality of points.

Detecting the display region based on the plurality of points may include detecting vertices of the display region from among the plurality of points based on positions and pixel values of the plurality of points, and detecting the display region based on the detected vertices.

The method may further include performing calibration of the display apparatus based on the detected display region.

### BRIEF DESCRIPTION OF THE DRAWINGS

These and/or other aspects will become apparent and more readily appreciated from the following detailed description, taken in conjunction with the accompanying drawings in which like reference numerals refer to like elements, and wherein:

FIG. 1 illustrates an example configuration of a display system;

FIG. 2 illustrates an example of an image of a display apparatus captured by an image capturing apparatus of FIG. 1;

FIG. 3 is a flowchart illustrating an example method of operating the display system of FIG. 1;

FIGS. 4A and 4B, FIGS. 5A and 5B, FIGS. 6A and 6B, FIGS. 7A and 7B, FIGS. 8A and 8B, and FIGS. 9A and 9B illustrate example images of a first pattern and a second pattern that are displayed by the display apparatus of FIG. 1;

FIGS. 10A and 10B illustrate examples of a first image and a second image;

FIG. 11 illustrates an example of a third image obtained based on the first image and the second image of FIGS. 10A and 10B;

FIG. 12 illustrates a configuration of an example display control apparatus;

FIG. 13 illustrates a configuration of an example display control apparatus;

FIGS. 14A and 14B and FIGS. 15A and 15B illustrate examples of an image of a first pattern and an image of a second pattern; and

FIGS. 16A, 16B, 16C, and 16D and FIGS. 17A, 17B, 17C, and 17D illustrate examples of a case of using two or more patterns.

### DETAILED DESCRIPTION

Reference will now be made in detail to various examples which are illustrated in the accompanying drawings, wherein like reference numerals refer to like elements throughout. In this regard, the examples may have different forms and should not be construed as being limited to the descriptions set forth herein. Accordingly, the examples are described below, by referring to the figures, to explain aspects of the examples. Expressions such as “at least one of,” when preceding a list of elements, modify the entire list of elements and may not modify the individual elements of the list.

Terms used in the disclosure will be briefly described and the examples will be described in detail.

The terms used in the disclosure have been selected from currently widely used general terms in consideration of the functions in the examples. However, the terms may vary according to the intention of one of ordinary skill in the art, case precedents, and the advent of new technologies. Also, for special cases, meanings of the terms selected by the applicant are described in detail in the description section. Accordingly, the terms used in the disclosure are defined based on their meanings in relation to the contents discussed throughout the specification, not necessarily by their simple meanings.

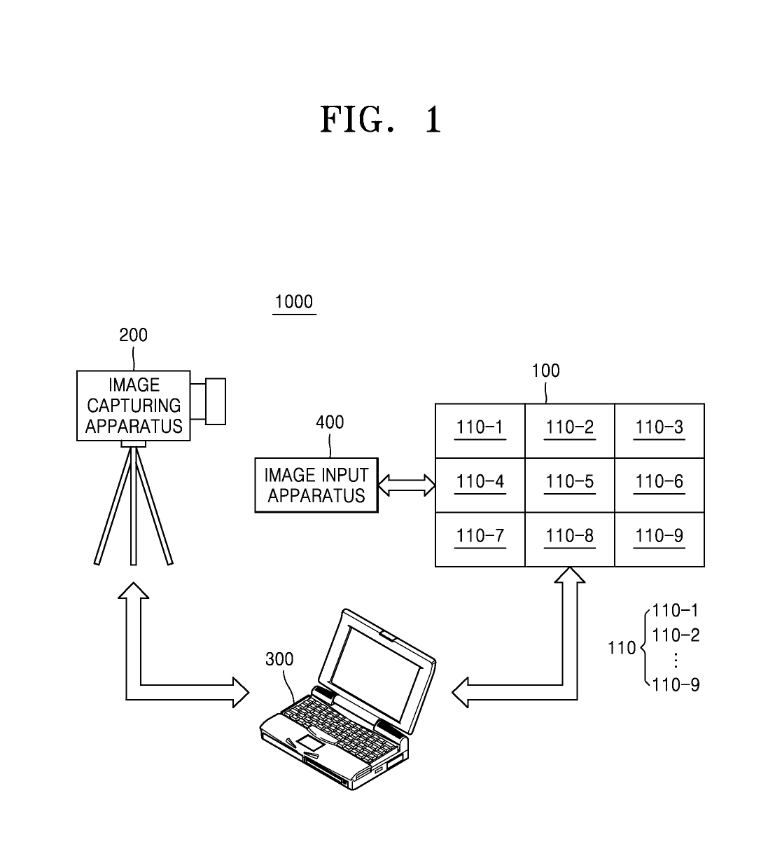

FIG. 1 illustrates a configuration of an example display system 1000.

Referring to FIG. 1, the display system 1000 may include a display apparatus 100, a display control apparatus 300, and an image capturing apparatus 200. The display system 1000 may further include an image input apparatus 400.

The display apparatus 100 may include at least one display module 110 (110-1˜110-9). The display module 110 may, for example, be implemented using various display apparatuses such as a liquid crystal display (LCD), a cathode ray tube (CRT) display, a plasma display panel (PDP) display, an organic light-emitting diode (OLED) display, a field emission display (FED), a light-emitting diode (LED) display, a vacuum fluorescence display (VFD), a digital light processing (DLP) display, a flat panel display (FPD), a three-dimensional (3D) display, a transparent display, or the like.

When the display apparatus 100 includes a plurality of display modules 110 as illustrated in FIG. 1, each of the display modules 110 may be referred to as a set. The display apparatus 100 may, for example, be an apparatus that is configured to use a plurality of sets, that is, the display modules 110, as one integrated display For example other words, the display modules 110 included in the display apparatus 100 may form one large screen (sometimes referred to in the art as a multi-display). Although FIG. 1 illustrates that the display apparatus 100 includes the first to ninth display modules 110-1˜110-9 that are a total of nine display modules arranged in the form of a 3×3 matrix, the number or array form of the display modules 110 included in the display apparatus 100 is not limited thereto. The display modules 110 may be arranged in various forms such as a step form or a pyramid form, in addition to the matrix form.

In another example, the display apparatus 100 may include only one display module 110. For example, the one display module 110 may serve as the display apparatus 100.

The display apparatus 100 may be variously implemented using a large format display (LFD) apparatus, a monitor for professionals, a broadcast display apparatus, a medical imaging apparatus, or the like.

The image capturing apparatus 200 may acquire an image by capturing an image of the display apparatus 100 and transfer the captured image of the display apparatus 100 to the display control apparatus 300. The image capturing apparatus 200 may be implemented using various apparatuses such as, for example, a camera or a camcorder.

The display control apparatus 300 may control the display apparatus 100. The display control apparatus 300 and the display apparatus 100 may be connected by wire or wirelessly. Also, the display control apparatus 300 may be connected to the image capturing apparatus 200 by wire or wirelessly. The apparatuses included in the display system 1000 may be wirelessly connected to each other via a router (not shown). The display control apparatus 300 may be implemented using various apparatuses such as, for example, a personal computer (PC), a server computer, a laptop computer, a portable electronic apparatus, or the like.

Although FIG. 1 illustrates that the image capturing apparatus 200 and the display control apparatus 300 are separately provided, the image capturing apparatus 200 may be implemented by being integrated with the display control apparatus 300.

The image input apparatus 400 may input an image to the display apparatus 100. Also, the image input apparatus 400 may provide a signal or voltage to the display apparatus 100 to prevent the display apparatus 100 from being turned off. The image input apparatus 400 may be implemented using various apparatuses such as, for example, a PC, a server computer, a laptop computer, a portable electronic apparatus, or the like. However, the image input apparatus 400 may be implemented by being integrated with the display control apparatus 300 or the display apparatus 100.

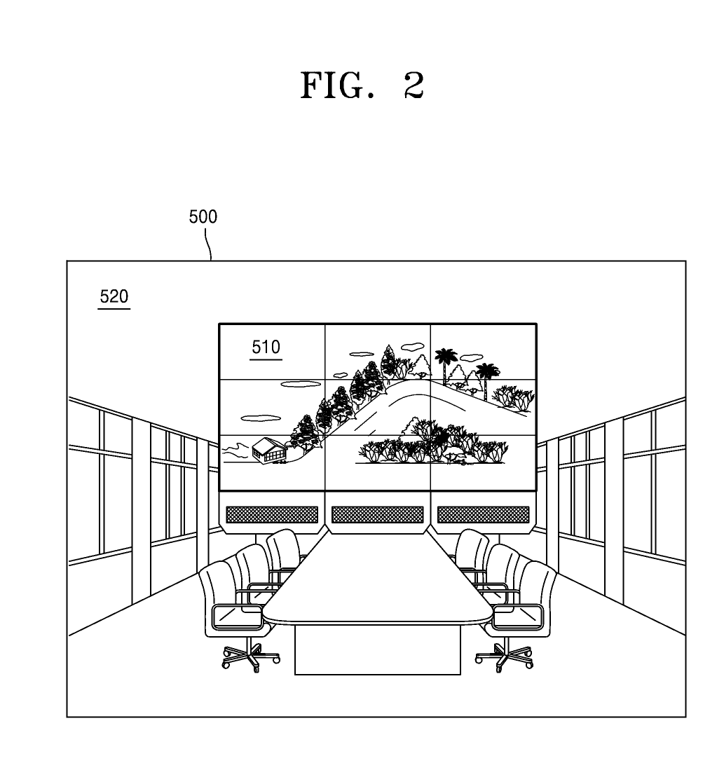

FIG. 2 illustrates an example of an image 500 of the display apparatus 100, captured by the image capturing apparatus 200 of FIG. 1.

Referring to FIGS. 1 and 2, the image 500 may include a display region 510 that is an image area of the display apparatus 100 and a background region 520 that is an image area of a surrounding environment in which the display apparatus 100 is situated. The image 500 may, for example, signify two-dimensional data formed of pixel values with respect to respective pixels that are discrete image elements. In the image 500, each of the display region 510 and the background region 520 may be a set of pixels.

For example, each pixel value may be RGB data or YUV data. RGB data may be represented by (R, G, B). R, G, and B are respectively red data, green data, and blue data. For example, when each data is represented by 8 bits, each of red color, green color, and blue color has one of 256 levels. As red color, green color, and blue color, each of which being represented by a respective level, are combined with one another, a color may be produced. For example, when RGB data is (255, 255, 255), white color is produced, and when RGB data is (0, 0, 0), black color is produced.

The display control apparatus 300 may, for example, detect the display region 510 that is an area of the display apparatus 100, from the image 500. A method whereby the display system 1000 detects the display region 510 of the display apparatus 100 from the image 500 will be described below in detail.

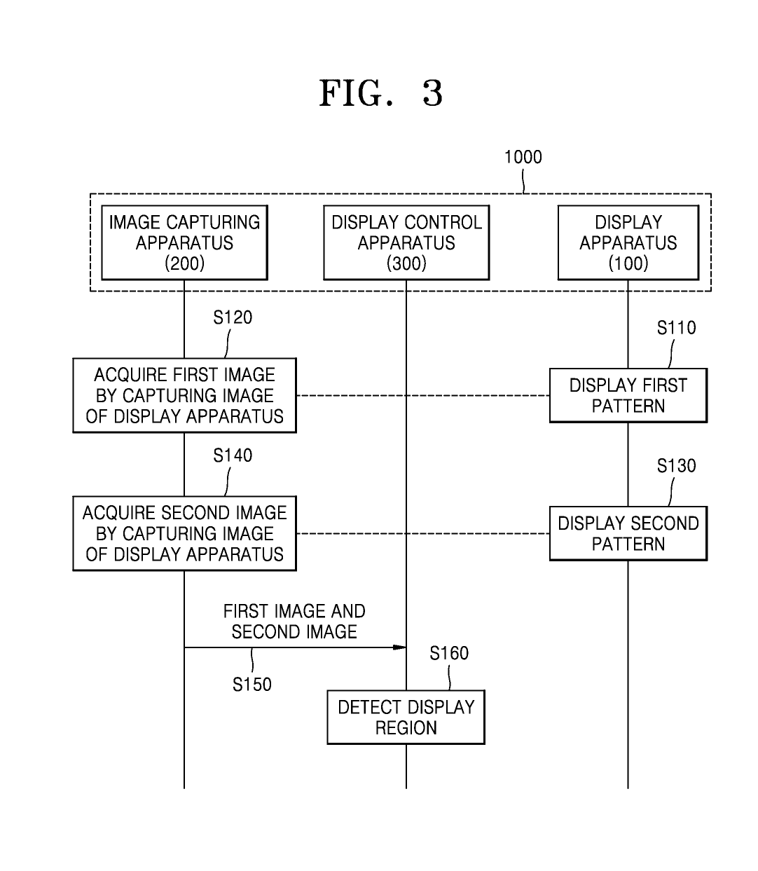

FIG. 3 is a flowchart illustrating an example method of operating the display system 1000 of FIG. 1.

Referring to FIGS. 1 and 3, the display apparatus 100 may display an image of a first pattern (S110). The image capturing apparatus 200 may acquire a first image by capturing an image of the display apparatus 100 that displays the image of the first pattern (S120). The display apparatus 100 may display an image of a second pattern (S130). The image capturing apparatus 200 may acquire a second image by capturing an image of the display apparatus 100 that displays the image of the second pattern (S140).

The image capturing apparatus 200 may capture an image of the display apparatus 100 while the display apparatus 100 displays the image of the first pattern. Also, while the display apparatus 100 displays the image of the second pattern, the image capturing apparatus 200 may capture an image of the display apparatus 100 again. Image capturing timing may be matched between the image capturing apparatus 200 and the display apparatus 100. The image capturing timing may be matched in various ways. For example, the image capturing timing may be matched through signal transmission among the apparatuses 100, 200, and 300 included in the display system 1000. In another example, the image capturing timing may be matched by using a timer or a clock signal. In another example, the display control apparatus 300 may match the image capturing timing by controlling the image capturing apparatus 200 or the display apparatus 100. As the image capturing timing is adjusted as above, the image capturing apparatus 200 may be configured to automatically capture an image of the display apparatus 100. In another example, the image capturing apparatus 200 may capture an image of the display apparatus 100 in a manual manner, such as, for example, by a user.

In order for the image capturing apparatus 200 to capture an image, the user may directly set an exposure or aperture condition of the image capturing apparatus 200. In another example, without any manual setting by a user, the image capturing apparatus 200 may automatically set the exposure or aperture condition and capture an image of the display apparatus 100, thereby acquiring the first image and the second image.

The display control apparatus 300 may transmit a control signal to the display apparatus 100 such that the display apparatus 100 displays the image of the first pattern and the image of the second pattern. The display apparatus 100 may receive the first pattern and the second pattern, as image data, from the display control apparatus 300. In another example, the first pattern and the second pattern may be internal patterns stored in the display apparatus 100.

The display control apparatus 300 may receive the first image and the second image from the image capturing apparatus 200 (S150). Although FIG. 3 illustrates that the first image and the second image are transmitted at the same time, the first image and the second image may be transmitted at different times.

The display control apparatus 300 may detect a display region that is an area of the display apparatus 100, from a third image obtained based on the first image and the second image (S160).

The display control apparatus 300 may perform calibration of the display apparatus 100 based on the detected display region. Also, the display control apparatus 300 may variously use the detected display region, for example, for controlling the display apparatus 100, in addition to the calibration thereof.

In FIG. 3, the display control apparatus 300 may acquire two images, that is, the first image and the second image that are captured images of the display apparatus 100 that displays images of two patterns at different times, that is, the image of the first pattern and the image of the second pattern. However, two or more patterns may be additionally used in the case of FIG. 3. For example, the image capturing apparatus 200 may acquire two or more images by capturing two or more images of the display apparatus 100 that displays images of two or more patterns at different times. Accordingly, the display control apparatus 300 may acquire two or more images that are captured images of the display apparatus 100 that displays images of two or more patterns.

The display apparatus 100 may further display images of different patterns, in addition to the image of the first pattern and the image of the second pattern. The display control apparatus 300 may acquire a plurality of images, in addition to the first image and the second image, by capturing images of the display apparatus 100 that displays images of different patterns.

The display control apparatus 300 may detect the display region based on the plurality of images. For example, the third image may be obtained based on the first image, the second image, and the plurality of images, and the display region may be detected from the third image.

As set forth above, third image may be obtained based on the first image and the second image. For example, when the display region is detected from the third image, accuracy in the detection of the display region may be increased by further considering the plurality of images. For example, a first display region may be detected from the third image and a second display region may be detected based on the plurality of images. Then, the first display region may be corrected by considering the second display region.

The image of the first pattern may include an area having the same shape as an area of the image of the second pattern. The image of the first pattern and the image of the second pattern may have different colors in the areas having the same shape. The image of the first pattern and the image of the second pattern are described in detail with reference to the following drawings.

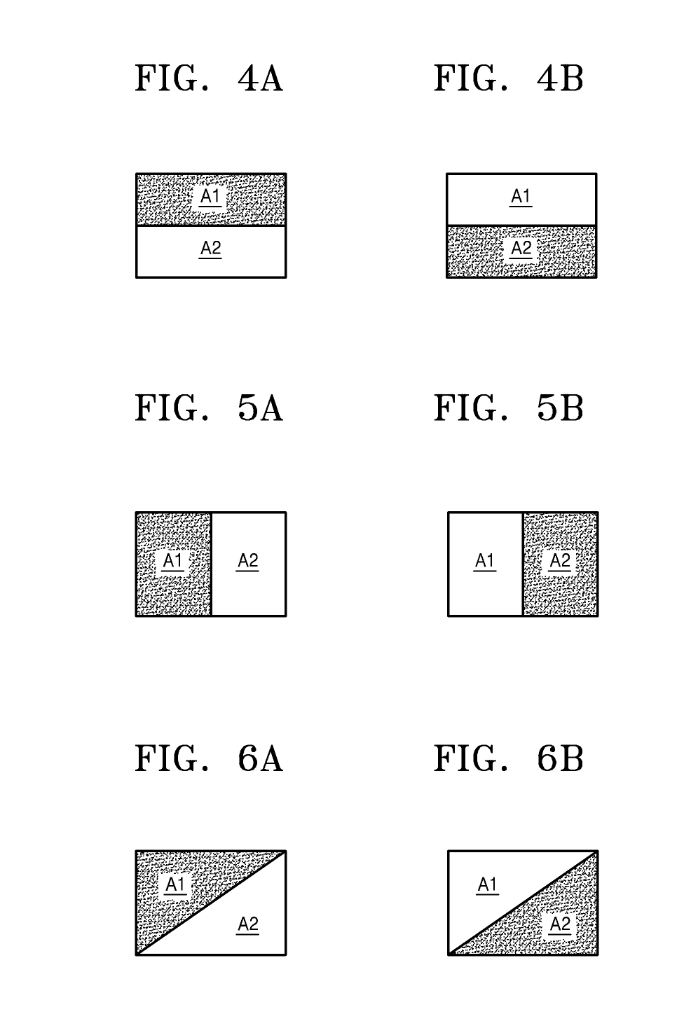

FIGS. 4A and 4B, FIGS. 5A and 5B, FIGS. 6A and 6B, FIGS. 7A and 7B, FIGS. 8A and 8B, and FIGS. 9A and 9B illustrate examples of the image of the first pattern and the image of the second pattern that are displayed by the display apparatus 100 of FIG. 1. FIGS. 4A, 5A, 6A, 7A, 8A, and 9A illustrate the images of the first pattern, whereas FIGS. 4B, 5B, 6B, 7B, 8B, and 9B illustrate the images of the second pattern.

FIGS. 4A and 4B respectively illustrate examples of the image of the first pattern and the image of the second pattern when the display apparatus 100 of FIG. 1 includes one display module.

Referring to FIGS. 4A and 4B, the image of the first pattern of FIG. 4A includes a first area A1 and a second area A2, and the image of the second pattern of FIG. 4B also includes a first area A1 and a second area A2 which have the same shapes as the first area A1 and second area A2 of the image of a first pattern of FIG. 4A. For example, the internal shapes of the image of the first pattern of FIG. 4A and the image of the second pattern of FIG. 4B are the same. Each of the image of the first pattern of FIG. 4A and the image of the second pattern of FIG. 4B is divided by a horizontal center line into two areas, that is, the first area A1 and the second area A2.

In the image of the first pattern of FIG. 4A, the first area A1 and the second area A2 respectively have a first color and a second color. The first color and the second color are different from each other. In the image of the second pattern of FIG. 4B, the first area A1 and the second area A2 respectively have the second color and the first color, complementarily to the image of the first pattern of FIG. 4A.

The first color and the second color may be complementary colors of each other. Any colors may be used so long as the first color and the second color are complementary colors of each other. When the first color has RGB data of (255, 255, 255), the RGB data of the second color may be (0, 0, 0). For example, when the first color is white, the second color may be black. In another example, when the first color has RGB data of (255, 0, 0), the RGB data of the second color is (0, 255, 255).

The area of the first area A1 may be equal to the area of the second area A2.

Also, the image of the first pattern of FIG. 4A and the image of the second pattern of FIG. 4B may have the same quantity of light. For example, when the area of the first area A1 is equal to the area of the second area A2 and the first color and the second color are different from each other, the quantity of light of the image of the first pattern of FIG. 4A and the quantity of light of the image of the second pattern of FIG. 4B may be the same.

The display apparatus 100 of FIG. 1 may display the image of the first pattern of FIG. 4A on the entire screen of the display apparatus 100 at a first time, and the image of the second pattern of FIG. 4B on the entire screen of the display apparatus 100 at a second time. Accordingly, when the image of the first pattern of FIG. 4A or the image of the second pattern of FIG. 4B is displayed on the screen of the display apparatus 100, the screen of the display apparatus 100 may be divided into the first area A1 and the second area A2 with respect to the horizontal center line. For example, at a first time, the image of the first pattern of FIG. 4A, in which the first area A1 is black and the second area A2 is white, may be displayed and, at a second time, the image of the second pattern of FIG. 4B, in which the first area A1 is white and the second area A2 is black, may be displayed.

Although FIGS. 4A and 4B illustrate that each of the image of the first pattern of FIG. 4A and the image of the second pattern of FIG. 4B is divided into the first area A1 and the second area A2 with respect to the horizontal center line, the images of FIGS. 4A and 4B are merely examples. As long as the internal shapes of the image of the first pattern of FIG. 4A and the image of the second pattern of FIG. 4B are the same, they may be have any shape.

FIGS. 5A and 5B and FIGS. 6A and 6B, illustrate examples of the image of the first pattern and the image of the second pattern when the display apparatus 100 of FIG. 1 includes one display module.

In FIGS. 5A and 5B, each of the image of the first pattern of FIG. 5A and the image of the second pattern of FIG. 5B is divided into the first area A1 and the second area A2 by a vertical central line. In FIGS. 6A and 6B, each of the image of the first pattern of FIG. 6A and the image of the second pattern of FIG. 6B is divided into the first area A1 and the second area A2 by a diagonal line. FIGS. 5A and 5B, and FIGS. 6A and 6B, are different from FIGS. 4A and 4B only with respect to their internal shapes, and all descriptions presented above with reference to FIGS. 4A and 4B may be applied to the examples illustrated in FIGS. 5A and 5B and FIGS. 6A and 6B.

In FIGS. 4A and 4B to FIGS. 6A and 6B, the screen of the display apparatus 100 of FIG. 1 including one display module may be divided into the first area A1 and the second area A2. However, FIGS. 4A and 4B to 6A and 6B are merely examples and each of the first area A1 and the second area A2 may be formed of separate sub-areas. For example, the entire screen may be divided into 2N sub-areas, where N is in integer. For example, while N sub-areas form the first area A1, the other N sub-areas may form the second area A2. A total size of the N sub-areas forming the first area A1 is the same as a total size of the other N sub-areas forming the second area A2.

FIGS. 7A and 7B illustrate examples of the image of the first pattern and the image of the second pattern when the display apparatus 100 of FIG. 1 includes two display modules. The two display modules may be referred to as first and second display modules.

Referring to FIGS. 7A and 7B, each of the first area A1 and the second area A2 may correspond to one display module. For example, the first area A1 may correspond to the first display module, and the second area A2 may correspond to the second display module. The descriptions presented above may be applied to the image of the first pattern of FIG. 7A and the image of the second pattern of FIG. 7B.

For example, at a first time, the display apparatus 100 of FIG. 1 displays the image of the first pattern of FIG. 7A, in which the first area A1, or the first display module, of the screen of the display apparatus 100 of FIG. 1 is black and the second area A2, or the second display module, of the screen of the display apparatus 100 of FIG. 1 is white. At a second time, the display apparatus 100 of FIG. 1 displays the image of the second pattern of FIG. 7B, in which the first area A1, or the first display module, is white and the second area A2, or the second display module, is black.

FIGS. 8A and 8B illustrate examples of the image of the first pattern and the image of the second pattern when the display apparatus 100 of FIG. 1 includes four display modules arranged in the form of a 2×2 matrix.

Referring to FIGS. 8A and 8B, the image of the first pattern of FIG. 8A includes the first area A1 and the second area A2, and the image of the second pattern of FIG. 8B includes the first area A1 and the second area A2 which have the same shape as the first area A1 and second area A2 of the image of the first pattern of FIG. 8A. Each of the first area A1 and the second area A2 is formed of separate sub-areas. Each sub-area may correspond to one display module.

In the image of the first pattern of FIG. 8A, the first area A1 and the second area A2 respectively have a first color and a second color. In the image of the second pattern of FIG. 8B, the first area A1 and the second area A2 respectively have the second color and the first color. The size of the first area A1 that is a total size of the sub-areas forming the first area A1 may be equal to the size of the second area A2 that is a total size of the sub-areas forming the second area A2.

The image of the first pattern of FIG. 8A and the image of the second pattern of FIG. 8B are different from those of FIGS. 4A and 4B to FIGS. 6A and 6B in that each of the first area A1 and the second area A2 is formed of the separate sub-areas, and the descriptions presented above may be applied to the image of the first pattern of FIG. 8A and the image of the second pattern of FIG. 8B.

FIGS. 9A and 9B illustrate examples of the image of the first pattern and the image of the second pattern when the display apparatus 100 of FIG. 1 includes nine display modules arranged in the form of a 3×3 matrix. In FIGS. 9A and 9B, like FIGS. 8A and 8B, each of the first area A1 and the second area A2 is formed of separate sub-areas, and each sub-area may correspond to one display module. The descriptions presented above may be applied to the image of the first pattern of FIG. 9A and the image of the second pattern of FIG. 9B.

When the display apparatus 100 of FIG. 1 includes a plurality of display modules and the image of the first pattern or the image of the second pattern is displayed as, for example, in FIGS. 7A and 7B to FIGS. 9A and 9B, each display module may have only one of a first color and a second color. For example, a screen of each display module is not divided and may correspond to the first area A1 or the second area A2, that is, only one area. However, this is merely an example and the screen of each display module may be divided into the first area A1 and the second area A2. In this case, when the image of the first pattern or the image of the second pattern is displayed, each display module may display both the first color and the second color. Each of the first area A1 and the second area A2 may be formed of separate sub-areas. For example, each of the image of the first pattern and the image of the second pattern of FIGS. 8A and 8B, and FIGS. 9A and 9B, may be displayed on the screen of each display module.

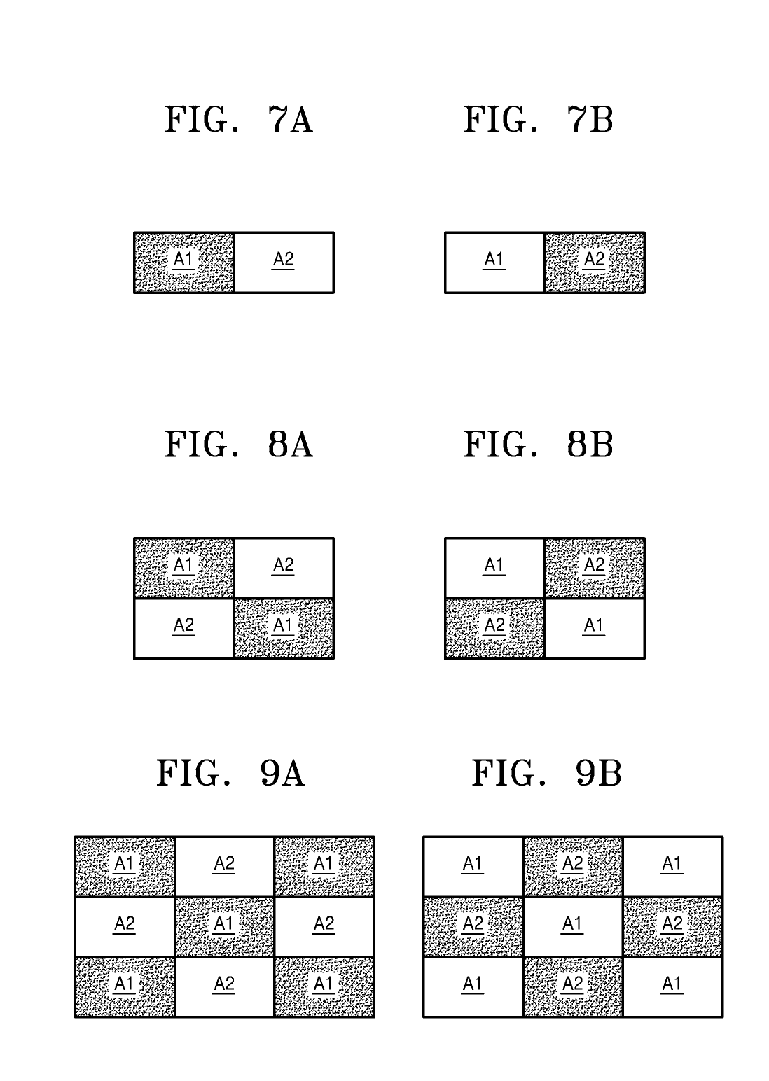

FIGS. 10A and 10B illustrate examples of a first image 610 and a second image 620.

Referring to FIGS. 10A and 10B, the first image 610 is an image obtained by capturing an image of the display apparatus 100 of FIG. 1 that displays the image of the first pattern of FIG. 9A. The second image 620 is an image obtained by capturing an image of the display apparatus 100 of FIG. 1 that displays the image of the second pattern of FIG. 9B.

The display control apparatus 300 of FIG. 1 may detect a display region that is an area of the display apparatus 100 of FIG. 1, from a third image obtained based on the first image 610 and the second image 620. The display control apparatus 300 of FIG. 1 may acquire the third image through a subtraction operation or a summing operation based on the first image 610 and the second image 620. However, the operation of acquiring the third image from the first image 610 and the second image 620, or image processing thereof, is not limited thereto.

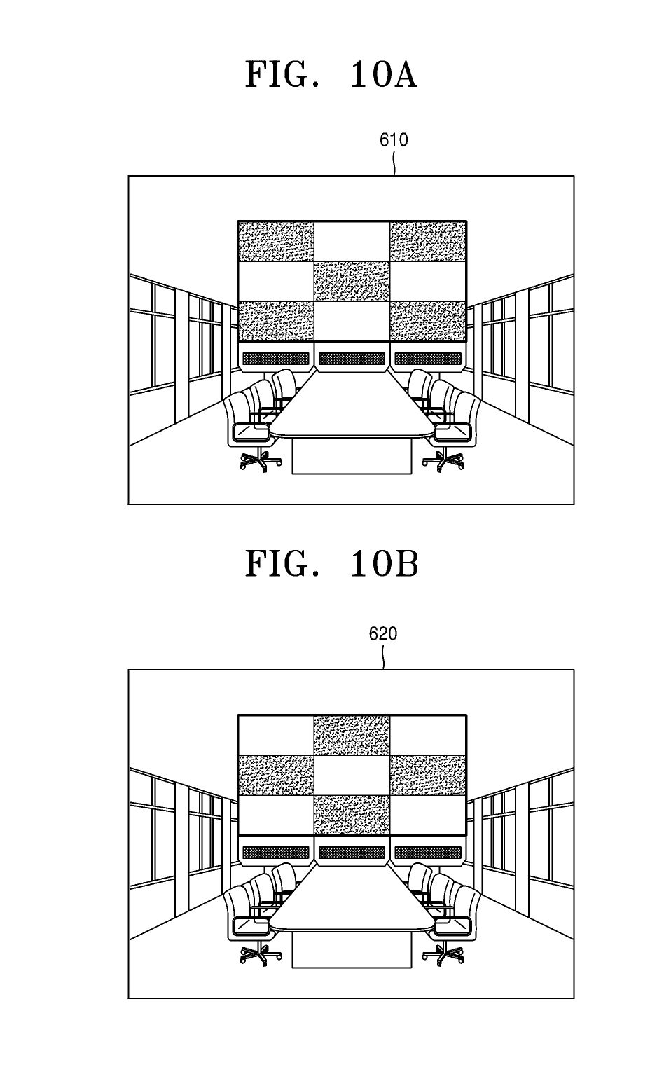

FIG. 11 illustrates an example of a third image 630 obtained based on the first image 610 and the second image 620 of FIGS. 10A and 10B.

Referring to FIGS. 10A and 10B and FIG. 11, the third image 630 may be obtained based on the first image 610 and the second image 620. For example, the third image 630 may be acquired through a subtraction operation or a summing operation of the first image 610 and the second image 620. The display control apparatus 300 of FIG. 1 may detect from the third image 630 a plurality of points 11-14, each point having a pixel value that is equal to or greater than a threshold value. Although FIG. 11 illustrates four points 11-14, more points may be detected from the third image 630. The threshold value may, for example, be set by a user or based on the size of data representing a pixel value of the third image 630.

The display control apparatus 300 of FIG. 1 may detect a display region 640 based on the points 11-14. The display control apparatus 300 of FIG. 1 may detect vertices of the display region 640 based on the positions and pixel values of the points 11-14 in the third image 630, and detect the display region 640 based on the detected vertices.

When the image of the first pattern of FIG. 9A and the image of the second pattern of FIG. 9B are in a complementary color relation, a difference between a pixel value to represent the image of the first pattern and a pixel value to represent the image of the second pattern may, for example, be at a maximum. For example, a pixel having an RGB data of (0, 0, 0) in the image of the first pattern corresponds to a pixel having an RGB data of (255, 255, 255) in the image of the second pattern. Accordingly, the difference is the maximum RGB data of (255, 255, 255). Accordingly, in the third image 630, the points that are assumed to be vertices of the display region 640 may be points having the maximum pixel values.

When the vertices of the display region 640 are detected from the points 11-14, the display control apparatus 300 of FIG. 1 may consider a shape formed by the vertices. For example, when the shape of the display apparatus 100 of FIG. 1 is a rectangle, the display control apparatus 300 of FIG. 1 may detect the vertices in consideration of whether the shape formed by the vertices detected from the points 11-14 is a quadrilateral. In this regard, the shape formed by the vertices may not necessarily be a rectangle and any quadrilateral shape including a trapezoid may suffice.

It is recommended that no big change is made in the surrounding environment in which the display apparatus 100 of FIG. 1 is situated while the first image 610 and the second image 620 are captured. Accordingly, the pixel values of a background region that is an image area of the surrounding environment in which the display apparatus 100 of FIG. 1 is situated may be almost the same as each other in the first image 610 and the second image 620. Accordingly, a background region portion may be almost removed in the third image 630 that is acquired through a subtraction operation between the first image 610 and the second image 620. However, some points may exist in the background region portion of the third image 630 due to a movement in the background or light. The above matters may be addressed by removing the background movement or blocking the light, and are solvable in consideration of not only the pixel value but also the position of a pixel.

The display control apparatus 300 of FIG. 1 may acquire an outline 20 connecting the detected vertices of the points 11-14 in the third image 630. The display control apparatus 300 of FIG. 1 may detect an area inside the outline 20 in the third image 630 to be the display region 640.

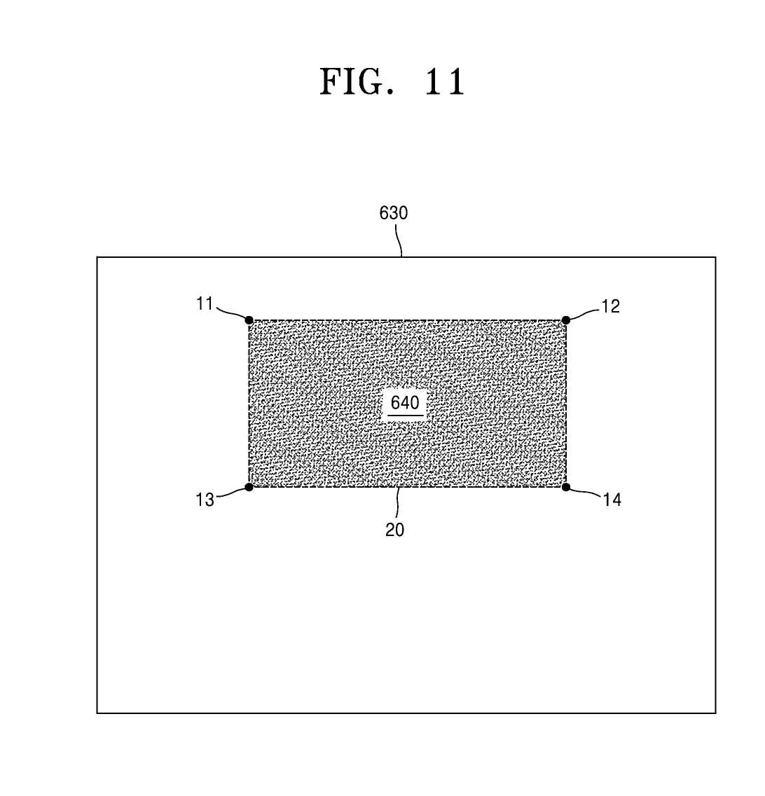

FIG. 12 illustrates a configuration of an example display control apparatus 700. The display control apparatus 700 of FIG. 12 may be an example of the display control apparatus 300 of FIG. 1. Accordingly, the descriptions of the display control apparatus 300 may be applied to the display control apparatus 700 of FIG. 12.

Referring to FIGS. 1 and 12, the display control apparatus 700 may include a data acquisition circuitry in the form, for example, of a data acquirer 710 and a data processor 720.

The data acquirer 710 may be configured to acquire a first image that is a captured image of the display apparatus 100 displaying the image of the first pattern, and a second image that is a captured image of the display apparatus 100 displaying the image of the second pattern. The data acquirer 710 may be configured to receive the first image and the second image from the image capturing apparatus 200. The data acquirer 710 may, for example, include one or more elements which are capable of acquiring data from an external device via various methods, for example, an interface, wired communication, wireless communication, or short-range communication.

The data acquirer 710 may further acquire a plurality of images that are captured images of the display apparatus 100 displaying images of different patterns, in addition to the first image and the second image.

The data processor 720 may be configured to detect a display region that is an area of the display apparatus 100 from the third image obtained based on the first image and the second image. The descriptions presented above may be applied to an operation of detecting the display region based on the first image and the second image, which is performed by the data processor 720. Also, when the data acquirer 710 further acquires a plurality of images, the data processor 720 may be configured to detect the display region further based on the plurality of images in addition to the first image and the second image. The data processor 720 may be variously implemented using, for example, a central processing unit (CPU), a microprocessor, a graphic processing unit (GPU) or any suitable processing circuitry, or any combination of the above.

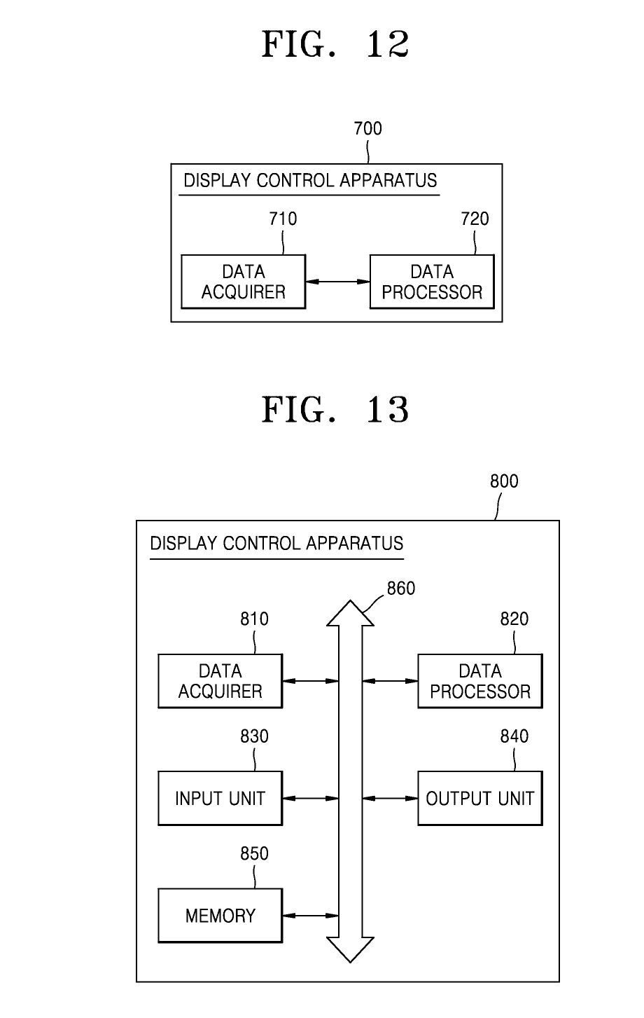

FIG. 13 illustrates a configuration of an example display control apparatus 800. The display control apparatus 800 of FIG. 13 may be an example of the display control apparatus 300 of FIG. 1. Accordingly, the descriptions of the display control apparatuses 300 and 700 may be applied to the display control apparatus 800 of FIG. 13.

Referring to FIGS. 1 and 13, the display control apparatus 800 may include a data acquisition circuitry, for example, in the form of a data acquirer 810 and a data processor 820. The display control apparatus 800 may further include an input unit 830, an output unit 840, and a memory 850. Various elements included in the display control apparatus 800 may be connected to each other via, for example, a bus 860. The input unit 830 and the output unit 840 may provide a user with a user interface (UI) for manipulating the display system 1000.

The memory 850 may store various information needed for the control of the display system 1000. The memory 850 may store the first pattern and the second pattern. The memory 850 may store at least one of the first image, the second image, and the third image. Also, the memory 850 may store information about the detected display region in the third image.

The input unit 830 may include circuitry configured to receive a command to operate the display system 1000 and various pieces of information about the operation of the display system 1000. An example of the input unit 830 may, for example, include a keyboard, a mouse, a touch screen, a voice recognizer, a fingerprint recognizer, and an iris recognizer, and may include other input apparatuses that will be apparent to one of ordinary skill in the art.

The output unit 840 may output the UI or information needed to operate the display system 1000 such as setting information of the display apparatus 100 or the image capturing apparatus 200. An example of the output unit 840 may include a speaker, a printer, a CRT display, an LCD display, a PDP display, an OLED display, an FED display, an LED display, a VFD display, a DLP display, an FPD display, a 3D display, and a transparent display, and may include other output apparatuses that will be apparent to one of ordinary skill in the art.

The input unit 830 and the output unit 840 may provide the UI which includes a setting for the number of display modules included in the display apparatus 100, a setting for each display module, and a setting for connection between the display modules. Also, a module identifier for identifying the respective display modules, an input source, or a connection cable between the display modules may be set through the UI. For example, when the module identifier is #1, it may indicate the first display module 110-1 of the display modules 110 of FIG. 1. When the module identifier is #2, it may indicate the second display module 110-2. In the same manner, the module identifier may be set for each of the third to ninth display modules 110-3˜110-9. When the module identifier is set for each of the display modules 110, the data processor 720 may determine an image of a pattern to be displayed by each of the display modules 110.

The connection between the display modules 110 may, for example, be set in a cascade method. For example, the first display module 110-1 may be connected to the display control apparatus 800. When the first display module 110-1 receives a signal from the display control apparatus 800, the first display module 110-1 may transmit the signal to the second display module 110-2 and then the second display module 110-2 may transmit the signal to the third display module 110-3. As such, one of the display modules 110 may receive a signal from the display control apparatus 800 and the signal may be sequentially transmitted in the display modules 110.

The data processor 820 may be configured to detect the display region that is an area of the display apparatus 100 from the third image obtained based on the first image and the second image. The data processor 820 may be configured to perform calibration of the display apparatus 100 based on the detected display region. The data processor 820 may be configured to perform the calibration based on the obtained captured image of the display apparatus 100. Also, the data processor 820 may be configured to use the detected display region for various purposes, for example, for controlling the display apparatus 100, in addition to the calibration.

Also, the data processor 820 may be configured to use the detected display region for various purposes other than the calibration.

Examples of an image of a pattern displayed by the display apparatus 100 of FIG. 1 are additionally described below with reference to the accompanying drawings. All the descriptions presented above may be applied to the image of the pattern described below.

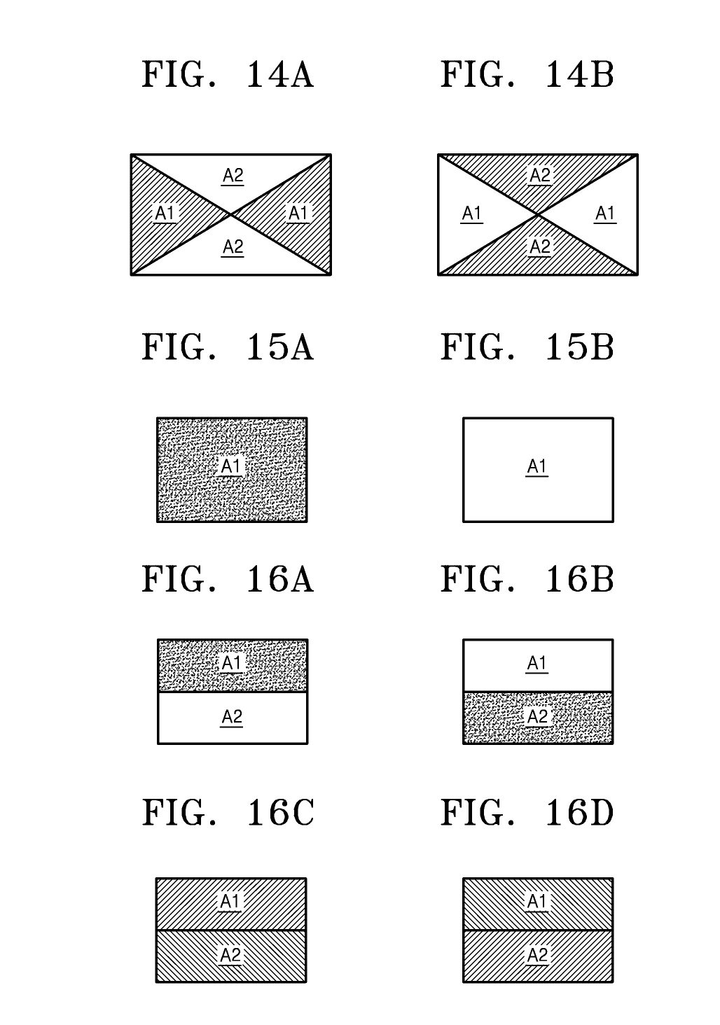

FIGS. 14A and 14B illustrate examples of an image of a first pattern and an image of a second pattern.

Referring to FIG. 14, the image of the first pattern of FIG. 14A may include a first area A1 and a second area A2 which have the same shape as a first area A1 and a second area A2 of the image of the second pattern of FIG. 14B. The first area A1 may be formed of two sub-areas, and the second area A2 may also be formed of two sub-areas. The four sub-areas forming the first area A1 and the second area A2 are divided by diagonal lines.

In the image of the first pattern of FIG. 14A, the first area A1 and the second area A2 respectively have a first color and a second color. The first color and the second color are different from each other. In the image of the second pattern of FIG. 14B, the first area A1 and the second area A2 respectively have the second color and the first color, complementarily to the image of the first pattern of FIG. 14A. The first color and the second color may be complementary colors of each other. The size of the first area A1 and the size of the second area A2 may be the same. Also, the image of the first pattern of FIG. 14A and the image of the second pattern of FIG. 14B may have the same quantity of light.

FIGS. 15A and 15B illustrate examples of an image of a first pattern and an image of a second pattern.

Referring to FIGS. 15A and 15B, the image of the first pattern of FIG. 15A and the image of the second pattern of FIG. 15B each include one area A1 having the same shape. The image of the first pattern of FIG. 15A and the image of the second pattern of FIG. 15B have different colors in the areas A1 having the same shape. In other words, the image of the first pattern of FIG. 15A may have a first color, and the image of the second pattern of FIG. 15B may have a second color. The first color and the second color may be complementary colors of each other. Also, the image of a first pattern of FIG. 15A and the image of a second pattern of FIG. 15B may have the same quantity of light.

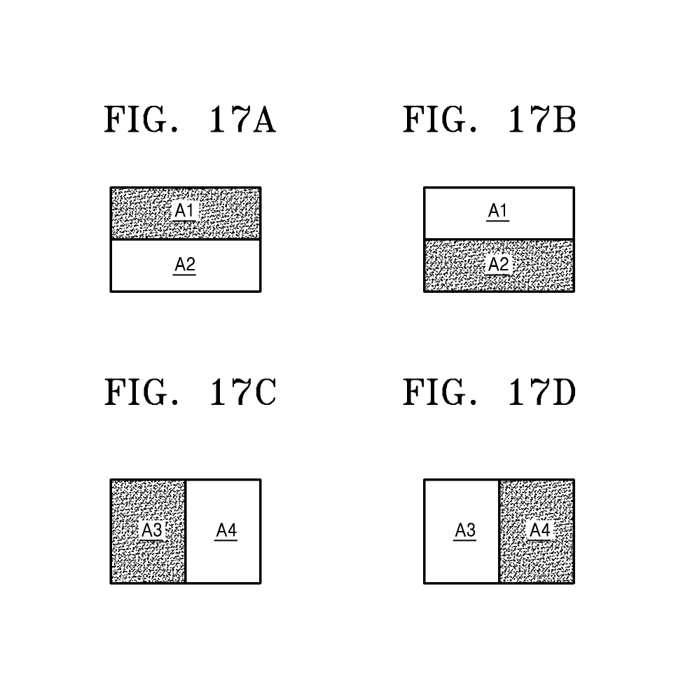

FIGS. 16A, 16B, 16C, and 16D and FIGS. 17A, 17B, 17C, and 17D illustrate examples using two or more patterns.

Referring to FIGS. 16A, 16B, 16C, and 16D, an image of a first pattern of FIG. 16A, an image of a second pattern of FIG. 16B, an image of a third pattern of FIG. 16C, and an image of a fourth pattern of FIG. 16D include a first area A1 and a second area A2 that have the same shape. The image of the first pattern of FIG. 16A, the image of the second pattern of FIG. 16B, the image of the third pattern of FIG. 16C, and the image of the fourth pattern of FIG. 16D may have different colors in the areas A1 and A2 having the same shape. For example, the first areas A1 of the image of the first pattern of FIG. 16A, the image of the second pattern of FIG. 16B, the image of the third pattern of FIG. 16C, and the image of the fourth pattern of FIG. 16D may have different colors from each other and the second areas A2 thereof may have different colors from each other.

For example, the first area A1 of the image of the first pattern of FIG. 16A may have a first color, the first area A1 of the image of the second pattern of FIG. 16B may have a second color, the first area A1 of the image of the third pattern of FIG. 16C may have a third color, and the first area A1 of the image of the fourth pattern of FIG. 16D may have a fourth color. The second area A2 of the image of the first pattern of FIG. 16A may have the second color, the second area A2 of the image of the second pattern of FIG. 16B may have the first color, the second area A2 of the image of the third pattern of FIG. 16C may have the fourth color, and the second area A2 of the image of the fourth pattern of FIG. 16D may have the third color. The first color and the second color may be complementary colors of each other, and the third color and the fourth color may be complementary colors of each other. For example, the first color may be white and the second color may be black, which is a complementary color of white, and the third color may be red and the fourth color may be cyan, which is a complementary color of red.

The image of the first pattern of FIG. 16A, the image of the second pattern of FIG. 16B, the image of the third pattern of FIG. 16C, and the image of the fourth pattern of FIG. 16D may be grouped in twos forming pairs. As illustrated in FIGS. 16A to 16D, the image of the first pattern of FIG. 16A and the image of the second pattern of FIG. 16B may form one pair, and the image of the third pattern of FIG. 16C and the image of the fourth pattern of FIG. 16D may also form one pair. The image of the first pattern of FIG. 16A and the image of the second pattern of FIG. 16B may display the first color and the second color, and the image of the third pattern of FIG. 16C and the image of the fourth pattern of FIG. 16D may display the third color and the fourth color.

Referring to FIGS. 17A, 17B, 17C, and 17D, each of the image of the first pattern of FIG. 17A and the image of the second pattern of FIG. 17B includes the first area A1 and the second area A2 that have the same shape. Also, each of the image of the third pattern of FIG. 17C and the image of the fourth pattern of FIG. 17D includes the third area A3 and the fourth area A4 that are areas having the same shape. The image of the first pattern of FIG. 17A and the image of the second pattern of FIG. 17B, each including the areas having the same shape, may form one pair. Likewise, the image of the third pattern of FIG. 17C and the image of the fourth pattern of FIG. 17D may also form one pair.

The image of the first pattern of FIG. 17A and the image of the second pattern of FIG. 17B may have different colors in the first area A1 and the second area A2 having the same shape. Also, the image of the third pattern of FIG. 17C and the image of the fourth pattern of FIG. 17D may have different colors in the third area A3 and the fourth area A4 having the same shape.

For example, the first area A1 and the second area A2 of the image of the first pattern of FIG. 17A may respectively have a first color and a second color, and the first area A1 and the second area A2 of the image of the second pattern of FIG. 17B may respectively have the second color and the first color. The third area A3 and the fourth area A4 of the image of the third pattern of FIG. 17C may respectively have the first color and the second color, and the third area A3 and the fourth area A4 of the image of the fourth pattern of FIG. 17D may respectively have the second color and the first color. The first color and the second color may be complementary colors of each other. In another example, the third area A3 and the fourth area A4 of the image of the third pattern of FIG. 17C may respectively have a third color and a fourth color, and the third area A3 and the fourth area A4 of the image of the fourth pattern of FIG. 17D may respectively have the fourth color and the third color. The third color and the fourth color may be complementary colors of each other.

When two or more patterns are used as in FIGS. 16A, 16B, 16C, and 16D and FIGS. 17A, 17B, 17C, and 17D, a variety of combinations may be available. For example, a variety of combinations may be available by changing the shape of an area included in an image of a pattern and the color of the area. Although FIGS. 16A, 16B, 16C, and 16D and FIGS. 17A, 17B, 17C, and 17D illustrate the images of four patterns, the patterns may be extended to four or more patterns.

As such, according to various examples, when an image of a display apparatus is captured, the surrounding environment is included with the display apparatus in the captured image. For example, a display region that is an image area with respect to the display apparatus in the image may be automatically detected by using two or more patterns.

According to various examples, a user does not need to separately set an exposure or aperture of an image capturing apparatus. The image capturing apparatus may acquire an image by capturing a display apparatus in an automatic mode without any particular setting by a user. When the image capturing apparatus captures an image in an automatic mode, the settings of an image capturing apparatus are changed according to an environment whenever an image is captured. The display apparatus sequentially displays an image of a first pattern and an image of a second pattern, and the image capturing apparatus captures two images of the display apparatus, thereby acquiring a first image and a second image. Also, during image capturing, the image of the first pattern and the image of the second pattern may be configured such that the image of the first pattern and the image of the second pattern have the same quantity of light.

According to various examples, since no time is needed to set an image capturing apparatus and no knowledge for setting the image capturing apparatus is needed, user convenience may be improved. Even when the image capturing apparatus is changed, a display region may be detected from a captured image. Accordingly, according to various examples, a display region may be easily and accurately detected from a captured image, which is convenient for a user. The setting of an image capturing apparatus may be separately performed, if a user desires.

The above-described examples can be implemented as computer programs and can be implemented in digital computers that execute the programs using a non-transitory computer readable recording medium.

Examples of the computer readable recording medium include magnetic storage media (e.g., ROM, floppy disks, hard disks, etc.), optical recording media (e.g., CD-ROMs, or DVDs), etc.

It should be understood that examples described herein should be considered in a descriptive sense only and not for purposes of limitation. Descriptions of features or aspects within each example should typically be considered as available for other similar features or aspects in other examples.

While one or more examples have been described with reference to the figures, it will be understood by those of ordinary skill in the art that various changes in form and details may be made therein without departing from the spirit and scope as defined by the following claims.

What is claimed is:

1. A display control apparatus comprising:
data acquisition circuitry configured to acquire a first image by capturing an image of a display apparatus that displays an image of a first pattern, and to acquire a second image by capturing an image of the display apparatus that displays an image of a second pattern; and
processing circuitry configured to detect a display region that is an image area of the display apparatus, from a third image obtained based on the first image and the second image.

2. The display control apparatus of claim 1, wherein the image of the first pattern comprises an area having a same shape as an area of the image of the second pattern, and the image of the first pattern and the image of the second pattern respectively display different colors in the areas having the same shape.

3. The display control apparatus of claim 2, wherein the image of the first pattern comprises a first area and a second area and the image of the second pattern comprises a first area and a second area having the same shape as the first area and second area of the image of the first pattern,
the first area and the second area of the image of the first pattern have a first color and a second color, respectively, and
the first area and the second area of the image of the second pattern have the second color and the first color, respectively.

4. The display control apparatus of claim 3, wherein the first color and the second color are complementary colors.

5. The display control apparatus of claim 3, wherein each of the first area and the second area comprises a plurality of sub-areas that are separated from each other.

6. The display control apparatus of claim 3, wherein a size of the first area is equal to a size of the second area.

7. The display control apparatus of claim 3, wherein the image of the first pattern and the image of the second pattern have a same quantity of light.

8. The display control apparatus of claim 1, wherein the data acquisition circuitry is further configured to acquire a plurality of images by capturing images of the display apparatus that displays images of different patterns, and
the processing circuitry is configured to detect the display region based on the plurality of images in addition to the first image and the second image.

9. The display control apparatus of claim 2, wherein the processing circuitry is configured to acquire the third image through a subtraction operation or a summing operation of the first image and the second image, to detect from the third image a plurality of points, each point having a pixel value equal to or greater than a threshold value, and to detect the display region based on the plurality of points.

10. The display control apparatus of claim 9, wherein the processing circuitry is configured to detect vertices of the display region from among the plurality of points based on positions and pixel values of the plurality of points, and to detect the display region based on the detected vertices.

11. The display control apparatus of claim 10, wherein the processing circuitry is configured to perform calibration of the display apparatus based on the detected display region.

12. The display control apparatus of claim 5, wherein the display apparatus comprises a plurality of display modules, and each of the plurality of display modules comprising at least one of the plurality of sub-areas.

13. A method of controlling a display, comprising:
acquiring a first image by capturing an image of a display apparatus that displays an image of a first pattern;
acquiring a second image by capturing an image of the display apparatus that displays an image of a second pattern; and
detecting a display region that is an image area of the display apparatus from a third image obtained based on the first image and the second image.

14. The method of claim 13, wherein the image of the first pattern comprises a first area and a second area and the image of the second pattern comprises a first area and a second area having a same shape as the first area and second area of the image of the first pattern,
the first area and the second area of the image of the first pattern have a first color and a second color, respectively, and
the first area and the second area of the image of the second pattern have the second color and the first color, respectively.

15. The method of claim 14, wherein the first color and the second color are complementary colors.

16. The method of claim 14, wherein the image of the first pattern and the image of the second pattern have a same quantity of light.

17. The method of claim 13, wherein detecting the display region comprises:
acquiring the third image through a subtraction operation or a summing operation of the first image and the second image;
detecting, from the third image, a plurality of points, each point having a pixel value equal to or greater than a threshold value; and
detecting the display region based on the plurality of points.

18. The method of claim 17, wherein detecting the display region based on the plurality of points comprises:
detecting vertices of the display region from among the plurality of points based on positions and pixel values of the plurality of points; and
detecting the display region based on the detected vertices.

19. The method of claim 13, further comprising performing calibration of the display apparatus based on the detected display region.

20. A non-transitory computer readable recording medium having recorded thereon a program, which when executed by a computer, performs the method defined in claim 13.
